(19) United States
(12) Patent Application Publication
(10) Pub. No.: US 2024/0041077 A1
(43) Pub. Date: Feb. 8, 2024

(54) MEAL REPLACEMENT BAR COMPRISING NATURAL AND/OR REAL FOOD INGREDIENTS AND METHODS FOR MAKING AND USING THE MEAL REPLACEMENT BAR

(71) Applicant: SOCIETE DES PRODUITS NESTLE S.A., Vevey (CH)

(72) Inventors: KHUSHAL BRIJWANI, Randolph, NJ (US); EVAN BERK, Livingston, NJ (US); VIVEK DILIP SAVANT, Bridgewater, NJ (US)

(21) Appl. No.: 18/257,006

(22) PCT Filed: Dec. 13, 2021
(86) PCT No.: PCT/EP2021/085359

§ 371 Date: Jun. 12, 2023

Related U.S. Application Data
(63) Continuation of application No. 17/123,443, filed on Dec. 16, 2020.

(51) Int. Cl. A23L 25/10; A23L 29/269; A23L 33/00; A23L 29/262; A23L 33/26; A23L 29/30; A23L 33/105; A23L 33/115; A23L 33/15; A23L 33/29

(52) U.S. Cl. CPC A23L 25/10; A23L 29/27; A23L 29/273; A23L 33/30; A23L 29/262; A23L 33/26; A23L 29/30; A23L 33/105; A23L 33/115; A23L 33/15; A23L 33/40; A23L 33/29

(57) ABSTRACT

The present disclosure generally relates to compositions and methods for suppressing food cravings, promoting weight loss, and/or preventing and/or treating overweight or obesity. More specifically, the present disclosure is directed to “clean label” meal replacement bars and methods for making and using same. The disclosed meal replacement bar contains a base material including real food and/or natural ingredients providing proteins, carbohydrates, fats, and/or fiber; at least one natural binding agent to bind together the base material; and vitamins and minerals to provide complete nutrition. The disclosed meal replacement bar preferably is made from less than 15 ingredients in total and provides about 160 kcal energy and about 16 g of protein for a bar of about 44 g; or provides about 200 kcal of energy and about 20 g of protein for a bar of about 55 g.

### BACKGROUND

The present disclosure generally relates to compositions and methods for suppressing food cravings, promoting weight loss, and/or preventing and/or treating overweight or obesity. More specifically, the present disclosure is directed to “clean label” meal replacement bars and methods for making and using same.

The prevalence of overweight and obesity are rising in the United States as well as globally. Long-term increased energy intake in excess of energy expenditure is a major contributor to obesity in the modern world. Weight control is typically attempted in the real world in the context of calorie restriction over periods of weeks and months in order to induce and maintain weight loss. This approach is typically achieved through reducing the amount or type of food consumed (i.e., reduction of portion sizes or eating less calorie-dense foods) or through replacement of meals with commercially available liquid preparations (nutritionally balanced total meal replacement products); both of which have been shown to be effective in weight loss.

Calorie restriction through reducing the amount of food consumed seems to be associated with increased subjective hunger and craving for food. The latter may lead to high failure and relapse rates compared to replacement of meals with nutritionally balanced meal replacement products.

Increasingly consumers are looking for cleaner and few ingredients across the variety of food categories and format. Meal replacement bars typically use one or more of polyols, artificial/synthetic emulsifiers, or stabilizers to form and shape the bar.

### SUMMARY

The present disclosure provides “clean label” meal replacement bars that are made with few ingredients and natural and/or real food ingredients, and yet these meal replacement bars meet dietary needs for macro- and micro-nutrients, for example when consumed as part of a calorie-restricted diet. Moreover, these meal replacement have organoleptically beneficial texture and mouthfeel.

Specifically, the meal replacement bars disclosed herein use at least one natural binding agent, such as one or more of honey, chicory root syrup, or dates paste, which achieve advantageous sensory attributes such as texture and mouthfeel and furthermore meet the nutritional requirements of a meal replacement program.

In some embodiments, the meal replacement bar can be made by forming a base of whey protein concentrate and whey crisps for providing crunchier texture along with almond butter that helps in creating a formable mass that is bound together by using at least one natural binding agent, such as one or more of honey, chicory root syrup, or dates paste, to produce a bar-like texture and mouthfeel. The formable mass can be supplemented with additional ingredients, such as one or more of oat flakes, flax seeds, vitamins and minerals to provide complete nutrition. Optionally, the resultant bar can be flavored, for example by adding a sweet flavor such as vanilla flavor, or by adding a savory flavor, such as a cheese, e.g., parmesan, and/or herb flavor. These ingredients not only successfully form the bar but also bring complete nutrition with a clean label.

In a particularly preferred non-limiting embodiment, the meal replacement bar contains only nine different ingredients and also a vitamin mineral premix, yet the meal replacement bar contains about 160 kcal of energy and about 16 g of protein for a bar of about 44 g. In another particularly preferred non-limiting embodiment, the meal replacement bar contains about 200 kcal of energy and about 20 g of protein for a bar of about 55 g.

The meal replacement bar can support weight management, promote weight loss, and/or treat or prevent obesity or overweight, for example for an individual on a weight loss program. The meal replacement bar can also be used for glycemic control.

Additional features and advantages are described herein and will be apparent from the following Figures and Detailed Description.

### BRIEF DESCRIPTION OF DRAWINGS

FIG. 1 shows the ingredients in two bags in Example 1.

FIG. 2 shows mixing ingredients with the date paste in the mixing bowl in Example 1.

FIG. 3 shows the mixture after bag 1 was added and mixed in Example 1.

FIG. 4 shows the mixture after bag 2 is added and mixed in Example 1.

FIG. 5 shows the mixture in the mold in Example 1.

FIG. 6 shows the mixture before being shaped in the mold in Example 2.

FIG. 7 shows the mixture in the mold in Example 2.

FIG. 8 shows a final bar of 44 g.

FIG. 9 shows the sensory map by Respondent 1.

FIG. 10 shows the sensory map by Respondent 2.

FIG. 11 shows the sensory map by Respondent 3.

FIG. 12 shows the sensory map by Respondent 4.

FIG. 13 shows the sensory map by Respondent 5.

FIG. 14 shows another sensory map by Respondent 5.

FIG. 15 shows the sensory map by Respondent 6.

FIG. 16 shows the appearance of Prototype 1.

FIG. 17 shows the appearance of Prototype 2.

FIG. 18 shows the appearance of Prototype 3.

FIG. 19 shows the appearance of Prototype 4.

### DETAILED DESCRIPTION

### Definitions

Some definitions are provided hereafter. Nevertheless, definitions may be located in the “Embodiments” section below, and the above header “Definitions” does not mean that such disclosures in the “Embodiments” section are not definitions.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “an ingredient or “the ingredient” means “at least one ingredient” and includes two or more ingredients.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 75 wt. % of the referenced components, preferably at least 85 wt. % of the referenced components, more preferably at least 95 wt. % of the referenced components, most preferably at least 98 wt. % of the referenced components.

The terms “at least one of” and “and/or” used in the respective context of “at least one of X or Y” and “X and/or Y” should be interpreted as “X,” or “Y,” or “X and Y.” For example, “at least one of honey or chicory root syrup” should be interpreted as “honey without chicory root syrup,” or “chicory root syrup without honey,” or “both honey and chicory root syrup.”

Where used herein, the terms “example” and “such as,” particularly when followed by a listing of terms, are merely exemplary and illustrative and should not be deemed to be exclusive or comprehensive.

“Prevention” includes reduction of risk and/or severity of a condition or disorder. The terms “treatment,” “treat,” “attenuate,” and “alleviate” include both prophylactic or preventive treatment (that prevent and/or slow the development of a targeted pathologic condition or disorder) and curative, therapeutic or disease-modifying treatment, including therapeutic measures that cure, slow down, lessen symptoms of, and/or halt progression of a diagnosed pathologic condition or disorder; and treatment of patients at risk of contracting a disease or suspected to have contracted a disease, as well as patients who are ill or have been diagnosed as suffering from a disease or medical condition. These terms do not necessarily imply that a subject is treated until total recovery. These terms also refer to the maintenance and/or promotion of health in an individual not suffering from a disease but who may be susceptible to the development of an unhealthy condition. These terms are also intended to include the potentiation or otherwise enhancement of one or more primary prophylactic or therapeutic measures. The terms “treatment,” “treat,” “attenuate” and “alleviate” are further intended to include the dietary management of a disease or condition or the dietary management for prophylaxis or prevention a disease or condition. As non-limiting examples, a treatment can be performed by a patient, a caregiver, a doctor, a nurse, or another healthcare professional.

The terms “food,” “food product” and “food composition” mean a product or composition that is intended for ingestion by an individual such as a human and provides at least one nutrient to the individual. The compositions of the present disclosure, including the many embodiments described herein, can comprise, consist of, or consist essentially of the essential elements and limitations described herein, as well as any additional or optional ingredients, components, or limitations described herein or otherwise useful in a diet.

As used herein, a food composition providing “complete nutrition” contains sufficient types and levels of macronutrients (protein, fats and carbohydrates) and also micronutrients to be sufficient to be a sole source of nutrition for the animal to which the food composition is administered. Individuals can receive 100% of their nutritional requirements from such complete food compositions.

The term “meal replacement” is a food composition administered and consumed by itself, without any other food composition. Preferably a meal replacement is administered and consumed at least one hour after and/or at least one hour before any other food composition (e.g., another meal replacement), more preferably at least two hours after and/or at least two hours before any other food composition, and most preferably at least three hours after and/or at least three hours before any other food composition. Meal replacements can be divided in two categories: (a) products presented as a replacement for the whole of the daily diet (“total diet replacement”) and (b) products presented as a replacement for one or more meals of the daily diet (“meal replacement”).

The term “meal replacement bar,” as used herein, refers to a physically discrete unit of a solid food composition comprising protein, carbohydrate, fat, vitamins, and minerals, suitable as a unitary dosage for human and animal subjects, each unit containing a predetermined quantity of the composition disclosed herein in an amount sufficient to produce the desired effect, in association with a pharmaceutically acceptable diluent, carrier or vehicle. The specifications for the meal replacement bar depend on the particular compounds employed, the effect to be achieved, and the pharmacodynamics associated with each compound in the host. In some embodiments, the meal replacement bar is formulated to provide complete nutrition to a human. The meal replacement bar can comprise about 20-60% carbohydrate, about 20-60% protein and about 10-30% fat by dry weight of the meal replacement bar. In a particularly preferred embodiment, the meal replacement bar can comprise about 40% carbohydrate, about 40% protein and about 20% fat by dry weight of the meal replacement bar.

A “low-fat” diet is a diet with less than 20% of the calories from fat, preferably less than 15% from fat. A “low-carbohydrate” diet is a diet with less than 20% of the calories from carbohydrates. A “low-calorie diet” is a diet with less calories per day relative to the individual's previous intake before the diet and/or a diet with less calories per day relative to an average person of similar body type. A “very low-calorie” diet is a diet with 800 kcal (3,300 kJ) per day or less.

The term “natural” means that the ingredient is not chemically synthesized and instead is derived from at least one natural source, for example an animal source such as an animal milk, eggs or fish oil; a plant source, such as a fruit, a vegetable; a legume, a grain, a nut, or a seed; or a mixture thereof. The term “real food” means a food typically ingested by an individual in a normal daily diet when the food is in its natural or prepared state, as opposed to any reduced components of the food.

A “subject,” “patient” or “individual” is a mammal, preferably a human.

“Overweight” is defined for a human as a BMI between 25 and 30. “Obese” is defined for a human as a BMI greater than 30. “Weight loss” is a reduction of the total body weight. Weight loss may, for example, refer to the loss of total body mass in an effort to improve fitness, health, and/or appearance. “Weight management” or “weight maintenance” relates to maintaining a total body weight. For example, weight management may relate to maintaining a BMI in the range of 18.5-25 which is considered to be normal.

As used herein, an “effective amount” is an amount that prevents a deficiency, treats a disease or medical condition in an individual or, more generally, reduces symptoms, manages progression of the diseases or provides a nutritional, physiological, or medical benefit to the individual. The relative terms “promote,” “improve,” “increase,” “enhance” and the like refer to the effects of the method disclosed herein which comprises administering meal replacements, relative to a diet of natural foodstuffs (e.g., fruits, vegetables, meats, grains, nuts, beans) but identical in daily caloric intake.

### EMBODIMENTS

An aspect of the present disclosure is a “clean label” meal replacement bar comprising at least one natural binding agent. Preferably the at least one natural binding agent is selected from the group consisting of honey, chicory root syrup, dates paste, and mixtures thereof. More preferably, at least two of these natural binding agents is used; and most preferably, all three of these natural binding agents are used. In an embodiment, the at least one natural binding agent is dispersed substantially homogeneously in the meal replacement bar. Preferably, the bar does not have a coating, and instead each of the ingredients of the bar can be dispersed substantially homogeneously throughout the meal replacement bar.

The at least one natural binding agent can be present in the meal replacement bar in an amount effective for a base material to be formed into a shape, such as rectangular or generally rectangular (e.g., rounded edges), and then maintain that shape. For example, the meal replacement bar can comprise about 9.0 wt. % to about 12.0 wt. % of chicory root syrup; about 8.0 wt. % to about 13.0 wt. % honey; and about 12.0 to about 18.0 wt. % of dates paste.

The “clean label” meal replacement bar further comprises a base material bound together by the at least one natural binding agent. The base material preferably comprises, consists essentially of, or consists of one or more real food and/or natural ingredients that each provide one or more of protein, carbohydrate, fat or fiber. The amounts of the one or more real food and/or natural ingredients can be formulated such that their addition to the at least one natural binding agent ensures that the meal replacement bar provides complete nutrition.

For example, the one or more real food and/or natural ingredients in the base material can comprise a natural protein source, such as one or more of milk protein, e.g., milk protein concentrate and/or milk protein isolate; a whey protein, e.g., whey protein concentrate, whey protein isolate, and/or whey protein hydrolysate; a casein, e.g., micellar casein; or a plant protein, e.g., soy protein, pea protein, and/or rice protein. The natural protein source can be in the form of a powder and/or a crisp (e.g., processed by extrusion). Additionally or alternatively, the natural protein source can include a butter (e.g., a paste) from one or more nuts or seeds, such as almond butter and/or peanut butter.

The one or more real food and/or natural ingredients or the natural protein source can comprise carbohydrates, fats and/or fiber.

The one or more real food and/or natural ingredients in the base material preferably comprise at least one grain or seed, such as oat (e.g., oat flakes), barley, wheat, flax seeds, and/or sunflower seeds.

In some embodiments, the meal replacement bar can be made by forming a base of whey protein concentrate and whey crisps for providing crunchier texture along with almond butter that helps in creating a formable mass that is bound together by using at least one natural binding agent, such as one or more of honey, chicory root syrup, or dates paste, to produce a bar-like texture and mouthfeel. The formable mass can be supplemented with additional ingredients, such as one or more of oat flakes, flax seeds, vitamins and minerals to provide complete nutrition. Optionally, the resultant bar can be flavored, for example by adding a sweet flavor such as vanilla flavor, or by adding a savory flavor. These ingredients not only successfully form the bar but also bring complete nutrition with a clean label.

In one embodiment, the meal replacement bar can be made by providing a base material comprising at least one real food and/or natural ingredient comprising proteins, carbohydrates, fats, and/or fiber; providing at least one natural binding agent to bind together the base material, wherein the at least one natural binding agent is selected from the group consisting of honey, chicory root syrup, dates paste, and mixtures thereof and is in an amount effective for the meal replacement bar to maintain a shape; and providing additional ingredients comprising vitamins and minerals to form a final mixture.

In one embodiment, the meal replacement bar can be made by mixing at least one natural binding agent with vitamins, minerals and/or a flavoring ingredient to form a mixture, wherein the at least one natural binding agent is selected from the group consisting of honey, chicory root syrup, dates paste, and mixtures thereof and is in an amount effective for the meal replacement bar to maintain a shape; mixing at least one real food and/or natural ingredient with the mixture to form a homogenous mixture; mixing a natural protein crisp with the homogenous mixture to form a final mixture, wherein the natural protein crisp stays intact during and after the mixing.

In one embodiment, the meal replacement bar can be made by mixing dry ingredients comprising at least one real food and/or natural ingredient comprising a natural protein crisp, vitamins, and/or minerals; and mixing wet ingredients comprising at least one natural binding ingredient and optionally a flavoring ingredient with the dry ingredients to form a final mixture, wherein the at least one natural binding agent is selected from the group consisting of honey, chicory root syrup, dates paste, and mixtures thereof and is in an amount effective for the meal replacement bar to maintain a shape, and the natural protein crisp stays intact during and after the mixing.

The “clean label” meal replacement bar may comprise vitamins and minerals according to the Recommended Daily Intake (RDI) of vitamins and minerals established by Title 21 of the Code of Federal Regulations, Volume 2 (revised Apr. 1, 2015), Chapter I, Subchapter B, Part 101, Subpart A, Section 101.9 (“Nutrition labeling of food”), subsection (c)(8)(iv). In this regard, the RDI is established for the vitamins and minerals as follows:
Vitamin A: 5,000 International Units
Vitamin C: 60 milligrams
Calcium: 1,000 milligrams
Iron: 18 milligrams
Vitamin D: 400 International Units
Vitamin E: 30 International Units
Vitamin K: 80 micrograms
Thiamin: 1.5 milligrams
Riboflavin: 1.7 milligrams
Niacin: 20 milligrams
Vitamin B6: 2.0 milligrams
Folate: 400 micrograms
Vitamin B12: 6 micrograms
Biotin: 300 micrograms
Pantothenic acid: 10 milligrams
Phosphorus: 1,000 milligrams
Iodine: 150 micrograms
Magnesium: 400 milligrams
Zinc: 15 milligrams
Selenium: 70 micrograms
Copper: 2.0 milligrams
Manganese: 2.0 milligrams
Chromium: 120 micrograms
Molybdenum: 75 micrograms
Chloride: 3,400 milligrams

The vitamins and minerals can be added to the “clean label” meal replacement bar in the form of a premix. In some embodiments, each of the meal replacement bar comprises vitamins and minerals in an amount of 10% to 40% of the RDI, for example 10 to 30% of the RDI or 20% to 30% of the RDI, and preferably comprises this amount for each of Vitamin A, Vitamin C, Calcium, Iron, Vitamin D, Vitamin E, Vitamin K, Thiamin, Riboflavin, Niacin, Vitamin B6, Folate, Vitamin B12, Biotin, Pantothenic Acid, Phosphorus, Iodine, Magnesium, Zinc, Selenium, Copper, Manganese, Chromium, Molybdenum, and Chloride.

In some embodiments, the meal replacement bar comprises about 100 to 300 kcal, preferably about 125 to 250 kcal, more preferably about 150 to 200 kcal, most preferably about 160 kcal; protein in an amount of about 8-30 g, preferably about 10 to 20 g, more preferably about 12 to 15 g, most preferably about 14 g; carbohydrates in an amount of about 10 to 30 g, preferably 15 to 25 g, more preferably about 18 to 22 g, most preferably about 20 g; and fat in an amount of 1 to 7 g, preferably 1 to 6 g, more preferably 2 to 5 g, most preferably about 3 g. These amounts are per unit, e.g., per separately packaged meal replacement bar, such as a meal replacement bar of 44 g or 55 g.

In a particularly preferred non-limiting embodiment, the meal replacement bar contains about 160 kcal of energy and about 16 g of protein for a bar of about 44 g. In another particularly preferred non-limiting embodiment, the meal replacement bar contains about 200 kcal of energy and about 20 g of protein for a bar of about 55 g.

Preferably the meal replacement bar is “clean label,” for example, does not contain any polyols, guar gum, maltodextrin, monosodium glutamate (MSG), xanthan gum, hydrogenated fat, carrageenan, monoglyceride, diglyceride, caseinate, microcrystalline cellulose (MCC), carboxymethylcellulose (CMC), or hydroxypropyl methylcellulose (HPMC).

Another aspect of the present disclosure is a method of making the meal replacement bar disclosed herein. In general, the meal replacement bar can be made by providing a base material comprising at least one real food and/or natural ingredient comprising proteins, carbohydrates, fats, and/or fiber; providing at least one natural binding agent to bind together the base material, wherein the at least one natural binding agent is selected from the group consisting of honey, chicory root syrup, dates, dates paste, and mixtures thereof and is in an amount effective for the meal replacement bar to maintain a shape; and providing additional ingredients comprising vitamins and minerals to form a final mixture.

In some embodiments, the meal replacement bar can be made by mixing at least one natural binding agent with vitamins, minerals, and/or a flavoring ingredient to form a mixture, wherein the at least one natural binding agent is selected from the group consisting of honey, chicory root syrup, dates paste, and mixtures thereof and is in an amount effective for the meal replacement bar to maintain a shape; mixing one or more real food and/or natural ingredient with the mixture to form a homogenous mixture; mixing a natural protein crisp with the homogenous mixture to form a final mixture. The natural protein crisp stays intact during and after the mixing.

In some embodiments, the meal replacement bar can be made by mixing dry ingredients comprising at least one real food and/or natural ingredient comprising a natural protein crisp, vitamins, minerals; and mixing wet ingredients comprising at least one natural binding ingredient and a flavoring ingredient with the dry ingredients to form a final mixture. The at least one natural binding agent is selected from the group consisting of honey, chicory root syrup, dates paste, and mixtures thereof and is in an amount effective for the meal replacement bar to maintain a shape, and the natural protein crisp stays intact during and after the mixing.

Further, the final mixture can be shaped in a mold. The molded final mixture can be cut into bars of any desired weight.

Preferably, the meal replacement bar is made from less than 15 ingredients in total, more preferably less than 10 ingredients in total, for example 9 ingredients in total.

Another aspect of the present disclosure is a method of reducing food cravings, promoting weight loss, and/or treating overweight or obesity, and/or glycemic control in an individual, such as a human, in need thereof (e.g., an overweight or obese human). The method comprises orally administering to the individual one or more meal replacement bars disclosed herein daily for a time period of at least three weeks in an amount that provides a caloric intake of 800-1,500 kcal/day, preferably 900-1,400 kcal/day, more preferably 1,000-1,300 kcal/day, and most preferably about 1,120 kcal/day. In some embodiments, the one or more meal replacement bars are administered to the human daily for a time period of at least one month, at least two months or at least three months.

The meal replacement bars can be administered as multiple separate meal replacements per day, preferably at least three separate meal replacements per day, more preferably at least four separate meal replacements per day, most preferably five separate meal replacements per day.

The one or more meal replacement bars administered daily are substantially the only food containing calories consumed by the individual during the time period (i.e., during the time period, the individual obtains approximately all of their nutrition from the one or more meal replacement bars, for example as a “total diet replacement.” As noted above, “food” includes beverages; but coffee, water and diet sodas (i.e., low or no calorie sodas) are considered foods that do not contain calories according to the present disclosure. “Substantially the only food or beverage containing calories consumed by the human during the time period” means that the human consumes less than 200 kcal daily from food or beverages other than the meal replacement bars disclosed herein, preferably less than 100 kcal daily, more preferably less than 50 kcal daily, most preferably about zero kcal daily.

Preferably the individual is a human of an age of 19-60 years from birth. In some embodiments, the human is otherwise healthy, i.e., overweight or obesity is the only disorder or condition afflicting the human. The human may or may not consume weight loss medication (e.g., Orlistat, Phentermine+Topiramate, Lorcaserin, Bupropion+Naltrexone, or Liraglutide) during the time period.

In another aspect of the present disclosure, a kit comprises separately packaged meal replacement bars disclosed herein. The kit comprises instructions identifying a daily number of the separately packaged meal replacement bars to consume to provide a daily caloric intake of 800-1,500 kcal/day, preferably 900-1,400 kcal/day, more preferably 1,000-1,300 kcal/day, and most preferably about 1,120 kcal/day. For example, the instructions can identify that the daily number of the separately packaged meal replacement bars to consume is five meal replacement bars. The kit comprises a number of the separately packaged meal replacement bars that is sufficient to provide the daily number of the separately packaged meal replacement bars for at least three weeks, preferably at least one month.

As used herein, including the appended claims, a “kit” means that the identified components are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be one or more containers that contain the identified components, and the one or more containers are physically associated such that they are considered a unit for manufacture, distribution, sale or use. A “sachet” is a small disposable bag or pouch, for example made of cellophane.

Those skilled in the art will understand that they can freely combine all features of the present invention disclosed herein. In particular, features described for the liquid dairy blend can be combined with the features of producing a liquid dairy blend and vice versa. Further, features described for different embodiments of the present invention may be combined.

### EXAMPLES

### Example 1: Preparation of Food Bars by Two-Stage Mixing

The food bars can be prepared as follows:

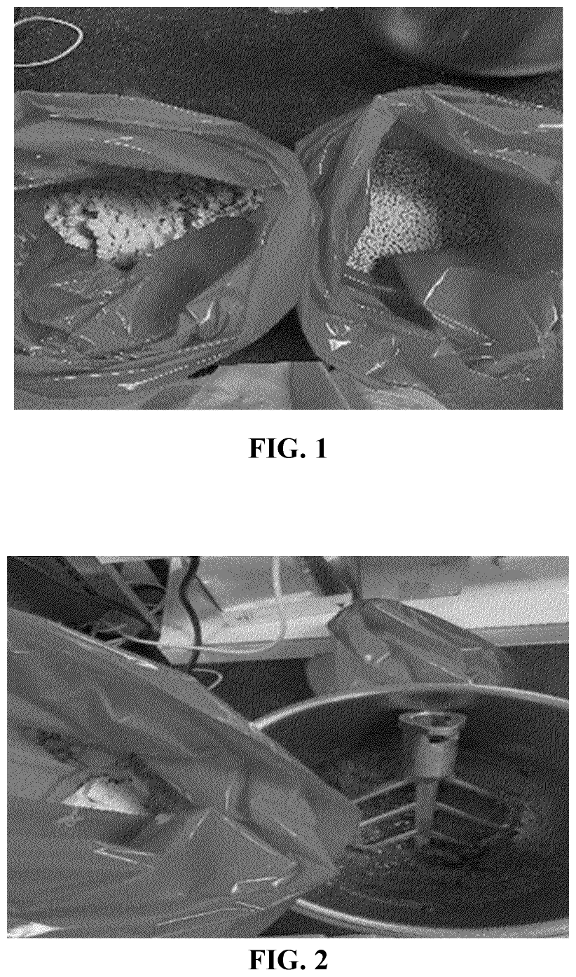

Weigh the following dry ingredients in bag 1 (left bag in FIG. 1):
Whey protein concentrate
Flax seed
Vitamin premix and
Oat flakes;

Weigh the following dry ingredient in bag 2 (right bag in FIG. 1);
Whey crisp

Weigh in mixing bowl:
Dates and/or date paste;

Mix dates until the texture becomes a paste;

Weigh in a mixing bowl with the date paste;
Almond butter
Sea salt
Mineral mix
Vanilla;

Mix all the ingredients in the mixing bowl (FIG. 2);

Add the following mildly heated (e.g., about 30° C.) and mixed wet ingredients to the mixing bowl:
Chicory root syrup
Honey;

Mix everything in the mixing bowl;

Add bag 1;

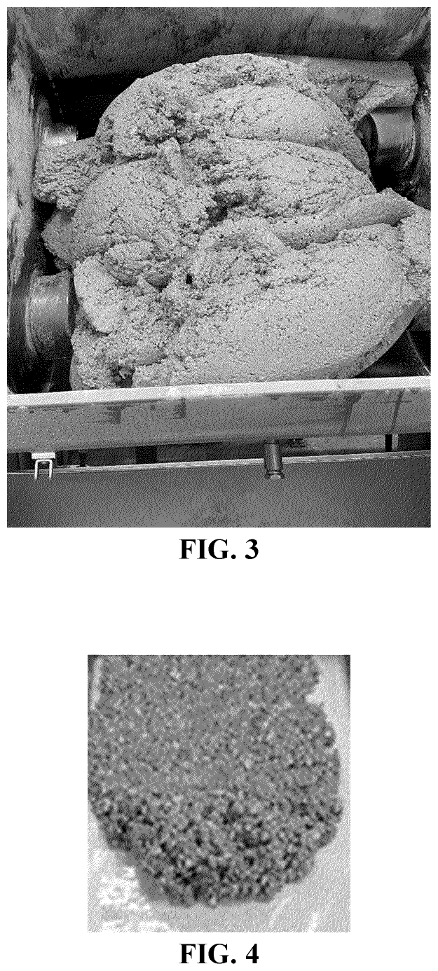

Mix until well bound/homogenous mixture (FIG. 3);

Add bag 2;

Mix carefully and make sure that Whey crisp stays intact during and after mixing (FIG. 4).

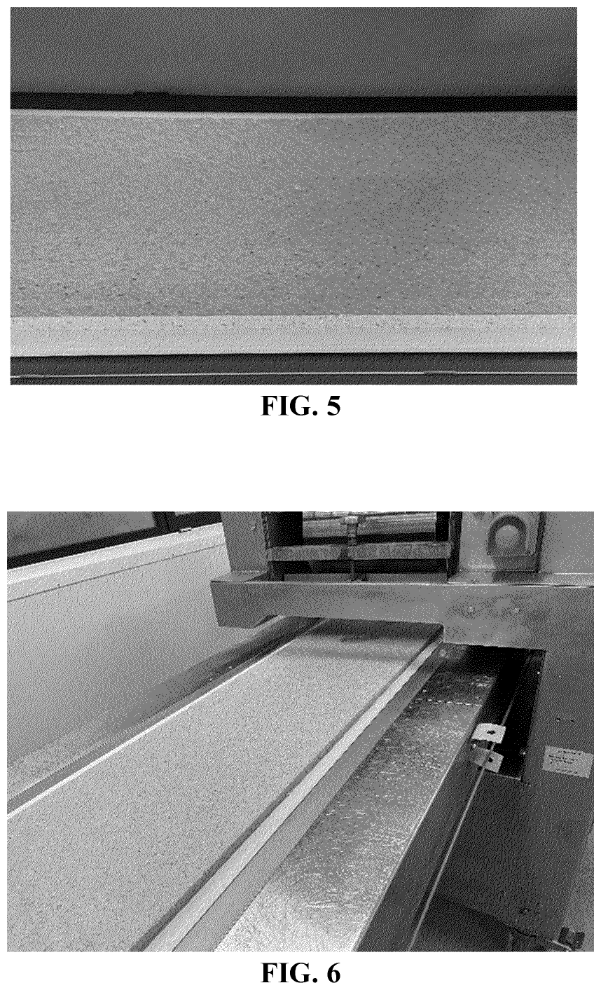

Add the mixture to the mold (FIG. 5).

### Example 2: Preparation of Food Bars by Dry Blending Followed by Binder Addition and Final Mixing

Alternatively, the food bars can also be prepared as follows:

Weigh the following dry ingredients in a bag:
Whey protein concentrate
Whey crisp
Flax seed
Vitamin mix
Mineral mix
Oat flakes and
Sea salt;

Mix ingredients from the bag in a mixing bowl;

Weigh the following wet ingredients:
Honey and
Chicory root syrup;

Heat up to about 30° C.;

Add the wet ingredients with the dry ingredients in the mixing bowl;

Add the rest of wet ingredients in the mixing bowl:
Honey
Chicory root syrup
Almond butter
Dates
Vanilla and/or cheese and/or herb;

Mix carefully until well bound/homogenous mixture and make sure Whey crisp stays intact during and after mixing (FIG. 6);

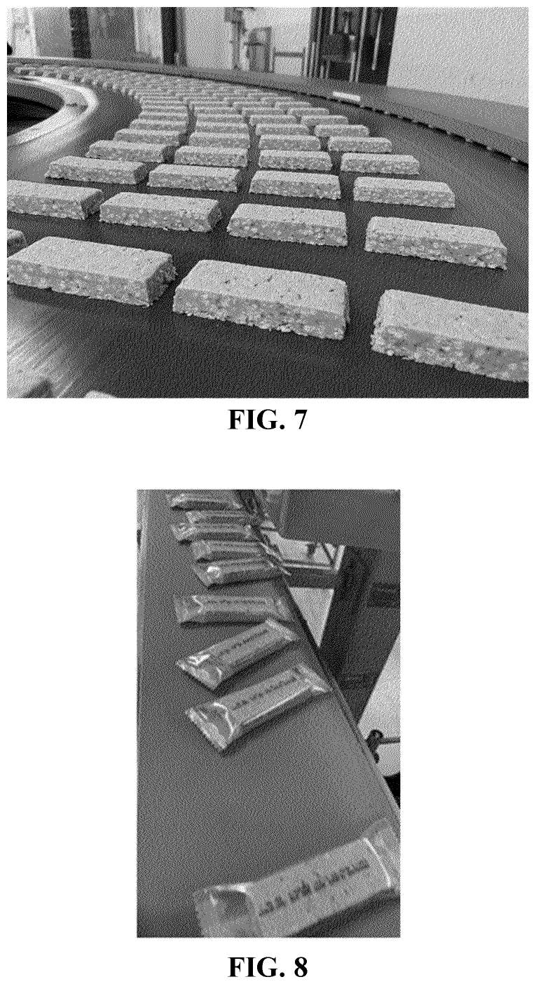

Shape the mixture in the mold (FIG. 7).

In both Examples 1 and 2, the molded mixture can be cut into bars of any desired weight, such as 44 g (e.g., for the US market), 68 g (e.g., for at least some non-US markets), or any other weights which, for example, meets the requirements of the specific market.

### Example 3: Example Recipes

Tables 1-7 below list some example recipes according to the present disclosure.

TABLE 1

| Variant 2 (modified) | | | | | | | |
|---|---|---|---|---|---|---|---|
| (almond/dates/whey bar) | Weight (g) | Calories | Fat, g | CHO, g | Sugar, g | Protein, g | Fiber, g |
| Chicory root syrup | 11.85 | 19.66 | 0.00 | 8.88 | 0.95 | 0.00 | 7.94 |
| Almond butter | 19.25 | 115.11 | 10.11 | 4.04 | 0.94 | 4.03 | 2.10 |
| Whey protein conc | 19.74 | 77.68 | 0.89 | 0.76 | 0.76 | 16.65 | 0.00 |
| Whey Crisp | 19.74 | 73.45 | 0.67 | 3.51 | 0.51 | 14.61 | 0.00 |
| Dates | 17.77 | 49.75 | 0.00 | 12.14 | 9.60 | 0.42 | 2.55 |
| Oat flakes | 0.99 | 3.74 | 0.07 | 0.58 | 0.01 | 0.13 | 0.08 |
| Vanilla | 0.49 | | | | | | |
| Honey | 8.88 | 27.01 | 0.00 | 7.32 | 6.75 | 0.00 | 0.00 |
| Vitamin-mineral Premix | 1.28 | | | | | | |
| Total | 100.00 | 366.40 | 11.75 | 37.25 | 19.51 | 35.84 | 12.66 |
| Bar, 44 g | 44 | 161.22 | 5.17 | 16.39 | 8.59 | 15.77 | 5.57 |

TABLE 2

| Variant 2 (modified) | | | | | | | |
|---|---|---|---|---|---|---|---|
| (almond/dates/whey bar) | Weight (g) | Calories | Fat, g | CHO, g | Sugar, g | Protein, g | Fiber, g |
| Chicory root syrup | 10.00 | 16.60 | 0.00 | 7.50 | 0.80 | 0.00 | 6.70 |
| Almond butter | 18.00 | 107.64 | 9.46 | 3.78 | 0.87 | 3.77 | 1.96 |
| Whey protein conc | 22.50 | 88.52 | 1.02 | 0.87 | 0.87 | 18.98 | 0.00 |
| Whey Crisp | 22.50 | 83.70 | 0.77 | 4.01 | 0.59 | 15.75 | 0.00 |
| Dates | 16.20 | 45.36 | 0.00 | 11.07 | 8.75 | 0.38 | 2.32 |
| Oat flakes | 0.99 | 3.74 | 0.07 | 0.58 | 0.01 | 0.13 | 0.08 |
| Vanilla | 0.49 | | | | | | |
| Honey | 8.00 | 24.32 | 0.00 | 6.59 | 6.08 | 0.00 | 0.00 |
| Vitamin-mineral Premix | 1.32 | | | | | | |
| Total | 100.00 | 369.89 | 11.31 | 34.39 | 17.96 | 39.01 | 11.06 |
| Bar, 44 g | 44 | 162.75 | 4.98 | 15.13 | 7.90 | 17.16 | 4.87 |

TABLE 3

| Variant 2 (modified) | | | | | | | |
|---|---|---|---|---|---|---|---|
| (almond/dates/whey bar) | Weight (g) | Calories | Fat, g | CHO, g | Sugar, g | Protein, g | Fiber, g |
| Chicory root syrup | 10.00 | 16.60 | 0.00 | 7.50 | 0.80 | 0.00 | 6.70 |
| Almond butter | 18.00 | 107.64 | 9.46 | 3.78 | 0.87 | 3.77 | 1.96 |
| Whey protein conc | 20.50 | 77.92 | 0.93 | 0.79 | 0.79 | 16.61 | 0.00 |
| Whey Crisp | 20.50 | 76.26 | 0.70 | 3.65 | 0.53 | 14.35 | 0.00 |
| Dates | 16.52 | 46.26 | 0.00 | 11.29 | 8.92 | 0.39 | 2.37 |
| Oat flakes | 0.99 | 3.75 | 0.07 | 0.58 | 0.01 | 0.13 | 0.08 |
| Vanilla | 0.49 | | | | | | |
| Honey | 9.00 | 27.36 | 0.00 | 7.42 | 6.84 | 0.00 | 0.00 |
| Vitamin-mineral Premix | 2.00 | | | | | | |
| Chia seeds | 2.00 | 8.86 | 0.632 | 0 | 0 | 0.45 | 0.686 |
| Total | 100.00 | 364.64 | 11.78 | 35.01 | 18.77 | 35.70 | 11.80 |
| Bar, 44 g | 44 | 160.44 | 5.18 | 15.40 | 8.26 | 15.71 | 5.19 |

TABLE 4

| Variant 2 (modified) | | | | | | | |
|---|---|---|---|---|---|---|---|
| (almond/dates/whey bar) | Weight (g) | Calories | Fat, g | CHO, g | Sugar, g | Protein, g | Fiber, g |
| Chicory root syrup | 9.00 | 14.94 | 0.00 | 6.75 | 0.72 | 0.00 | 6.03 |
| Almond butter | 17.35 | 103.75 | 9.12 | 3.65 | 0.84 | 3.64 | 1.89 |
| Whey protein conc | 21.50 | 82.58 | 0.97 | 0.83 | 0.83 | 17.63 | 0.00 |
| Whey Crisp | 20.50 | 76.26 | 0.70 | 3.65 | 0.53 | 14.35 | 0.00 |
| Dates | 17.52 | 49.06 | 0.00 | 11.97 | 9.46 | 0.41 | 2.51 |
| Oat flakes | 0.99 | 3.75 | 0.07 | 0.58 | 0.01 | 0.13 | 0.08 |
| Vanilla | 0.49 | | | | | | |
| Honey | 8.00 | 24.32 | 0.00 | 6.59 | 6.08 | 0.00 | 0.00 |
| Vitamin-mineral Premix | 1.50 | | | | | | |
| Chia seeds | 2.00 | 8.86 | 0.632 | 0 | 0 | 0.45 | 0.686 |
| KCl | 0.70 | | | | | | |
| Salt | 0.45 | | | | | | |
| Total | 100.00 | 363.52 | 11.49 | 34.02 | 18.47 | 36.61 | 11.20 |
| Bar, 44 g | 44 | 159.95 | 5.05 | 14.97 | 8.13 | 16.11 | 4.93 |

TABLE 5

| Variant 2 (modified) | | | | | | | |
|---|---|---|---|---|---|---|---|
| (almond/dates/whey bar) | Weight (g) | Calories | Fat, g | CHO, g | Sugar, g | Protein, g | Fiber, g |
| Chicory root syrup | 9.00 | 14.94 | 0.00 | 6.75 | 0.72 | 0.00 | 6.03 |
| Almond butter | 17.35 | 103.75 | 9.12 | 3.65 | 0.84 | 3.64 | 1.89 |
| Whey protein conc | 21.50 | 82.58 | 0.97 | 0.83 | 0.83 | 17.63 | 0.00 |
| Whey Crisp | 20.50 | 76.26 | 0.70 | 3.65 | 0.53 | 14.35 | 0.00 |
| Dates | 17.52 | 49.06 | 0.00 | 11.97 | 9.46 | 0.41 | 2.51 |
| Oat flakes | 0.99 | 3.75 | 0.07 | 0.58 | 0.01 | 0.13 | 0.08 |
| Vanilla | 0.49 | | | | | | |
| Honey | 9.15 | 27.82 | 0.00 | 7.54 | 6.95 | 0.00 | 0.00 |
| Vitamin-mineral Premix | 1.50 | | | | | | |
| Flax seeds | 2.00 | 8.86 | 0.64 | 0.69 | 0.032 | 0.5 | 0.54 |
| Total | 100.00 | 367.01 | 11.49 | 35.65 | 19.38 | 36.66 | 11.05 |
| Bar, 44 g | 44 | 161.49 | 5.06 | 15.69 | 8.53 | 16.13 | 4.86 |

TABLE 6

| Variant 2 (modified) | | | | | | | |
|---|---|---|---|---|---|---|---|
| (almond/dates/whey bar) | Weight (g) | Calories | Fat, g | CHO, g | Sugar, g | Protein, g | Fiber, g |
| Chicory root syrup | 9.00 | 14.94 | 0.00 | 6.75 | 0.72 | 0.00 | 6.03 |
| Almond butter | 17.35 | 103.75 | 9.12 | 3.65 | 0.84 | 3.64 | 1.89 |
| Whey protein conc | 21.50 | 82.58 | 0.97 | 0.83 | 0.83 | 17.63 | 0.00 |
| Whey Crisp | 20.50 | 76.26 | 0.70 | 3.65 | 0.53 | 14.35 | 0.00 |
| Dates | 17.52 | 49.06 | 0.00 | 11.97 | 9.46 | 0.41 | 2.51 |
| Oat flakes | 0.99 | 3.75 | 0.07 | 0.58 | 0.01 | 0.13 | 0.08 |
| Vanilla | 0.49 | | | | | | |
| Honey | 8.15 | 24.78 | 0.00 | 6.72 | 6.19 | 0.00 | 0.00 |
| Vitamin-mineral Premix | 1.50 | | | | | | |
| Walnuts | 3.00 | 13.29 | 2.055 | 0.099 | 0.078 | 0.441 | 0.105 |
| Total | 100.00 | 368.40 | 12.91 | 34.24 | 18.67 | 36.60 | 10.62 |
| Bar, 44 g | 44 | 162.10 | 5.68 | 15.07 | 8.21 | 16.10 | 4.67 |

TABLE 7

| Variant 2 (modified) | | | | | | | |
|---|---|---|---|---|---|---|---|
| (almond/dates/whey bar) | Weight (g) | Calories | Fat, g | CHO, g | Sugar, g | Protein, g | Fiber, g |
| Chicory root syrup | 9.00 | 14.94 | 0.00 | 6.75 | 0.72 | 0.00 | 6.03 |
| Almond butter | 13.50 | 80.73 | 7.09 | 2.84 | 0.66 | 2.83 | 1.47 |
| Whey protein conc | 24.50 | 94.10 | 1.11 | 0.94 | 0.94 | 20.09 | 0.00 |
| Whey Crisp | 20.50 | 76.26 | 0.70 | 3.65 | 0.53 | 14.35 | 0.00 |
| Dates | 12.79 | 35.81 | 0.00 | 8.74 | 6.91 | 0.30 | 1.83 |
| Oat flakes | 0.99 | 3.75 | 0.07 | 0.58 | 0.01 | 0.13 | 0.08 |
| Vanilla | 0.49 | | | | | | |
| Honey | 12.15 | 36.94 | 0.00 | 10.01 | 9.23 | 0.00 | 0.00 |
| Vitamin Premix | 0.50 | | | | | | |
| Flax seeds | 2.00 | 8.86 | 0.64 | 0.69 | 0.032 | 0.5 | 0.54 |
| r Potassium Phosphate Dibasic INS340ii | 1.50 | | | | | | |
| r Potassium Chloride INS508 | 0.20 | | | | | | |
| r Salt NaCl | 0.38 | | | | | | |
| Mineral premix | 1.50 | | | | | | |
| Total | 100.00 | 351.39 | 9.61 | 34.20 | 19.03 | 38.20 | 9.95 |
| Bar, 44 g | 44 | 154.61 | 4.23 | 15.05 | 8.37 | 16.81 | 4.38 |

Table 8 below shows non-limiting examples of recipe changes and ratios of ingredients that could deliver a successful bar industrially with acceptable texture and mouthfeel and meeting the nutritional guidelines of many markets.

| | | | | | Quantity in | | TS per |
|---|---|---|---|---|---|---|---|
| | | Quantity/ | | Input | dry matter/ | | Primary |
| Description | | 100 g | | TS % | 100 g | | Output % |
| r Protein Whey Concentrate 81% Fonterra 510 | | 24.5 | | 96 | 23.52 | | 26.225 |
| r Whey Crisp 70% Protein | | 20.5 | | 95 | 19.475 | | 21.714 |
| r Almond Butter Natural | | 13.75 | | 97.59 | 13.419 | | 14.962 |
| r Dates Paste | | 13.49 | | 78.89 | 10.642 | | 11.866 |
| Honey Liquid | | 11.2 | | 80.2 | 8.982 | | 10.015 |
| r Inuline Liquid 75% TS | | 9 | | 75 | 6.75 | | 7.526 |
| r Flax Seeds Dry | | 2 | | 95 | 1.9 | | 2.118 |
| r Mineral Premix Helios Bars Global | | 1.5 | | 95 | 1.425 | | 1.589 |
| r Potassium Phosphate Dibasic INS340ii | | 1.5 | | 98.3 | 1.475 | | 1.644 |
| r Oat Flakes Moore Mills 16.89% Protein | | 0.99 | | 90 | 0.891 | | 0.993 |
| r Vitamin Premix Helios Bars Global | | 0.5 | | 95 | 0.475 | | 0.53 |
| r Flavor Vanilla Natural Liquid Givaudan AG-835-027-0 | | 0.49 | | 51.5 | 0.154 | | 0.172 |
| r Salt NaCl | | 0.38 | | 99.8 | 0.379 | | 0.423 |
| r Potassium Chloride INS508 | | 0.2 | | 100 | 0.2 | | 0.223 |
| r Walnut Pieces | | 0 | | 97 | 0 | | 0 |
| r Chia Seeds Dry | | 0 | | 0 | 0 | | 0 |
| TOTAL | 100.000 | 100 | g | 89.687 | 89.687 | g | 100 |

### Example 4: Sensory Mapping of Commercial Weight Loss Bars and 4 Sweet Prototypes According to the Present Disclosure

Preparation was the same for all products tested. Products were cut into approximately 1 inch pieces and served in clear 2 ounce soufflé cups each with a clear lid.

Respondents were given a large sheet of paper and asked to map the products in a napping style: Products that are closer together are more similar, and products that are further away from each other are more different. Due to the wide variety of sensory differences, they were allowed to define which dimensions to use for their own map. Respondents were instructed to refrain from mapping on specific flavor notes (i.e. cherry flavor intensity), but rather keep it more broad for the purposes of this mapping. Respondents were also instructed to write down descriptions of the products next to their point on the map.

The respondents mapped the products most often on flavor intensity, off-notes, sticky and crunchy. Some also mapped the products by the number of inclusions or food pieces. The respondents commented mostly on texture attributes with descriptions such as crispy, chewy, soft/hard/firm, sticky-to-teeth, mealy, and chalky.

Bars differed in appearance attributes including frequency of inclusions, size and type of inclusions, compaction, shininess, enrobement, thickness, and shape.

Further, regardless of the dimensions chosen by the respondents, the four prototypes were placed close together on each respondent's individual maps, indicating the differences between the prototypes are small relative to the differences in the sample commercial products.

All prototypes were described as having primarily nutty flavor characteristics similar to some tested commercial products (BSC Clean bar, Flexi bar), whereas other tested commercial products were fruity/tart (Barley+bar, Keto Brownie bite, Planet food bar). Regarding the appearance, most but not all, of the tested commercial products contained pieces of fruit or grain that were recognizable, whereas the prototypes each had a primary base that appeared more doughy. There were also clearly appearance differences in the dimensions of inclusions (number and size), visual compaction, and shininess.

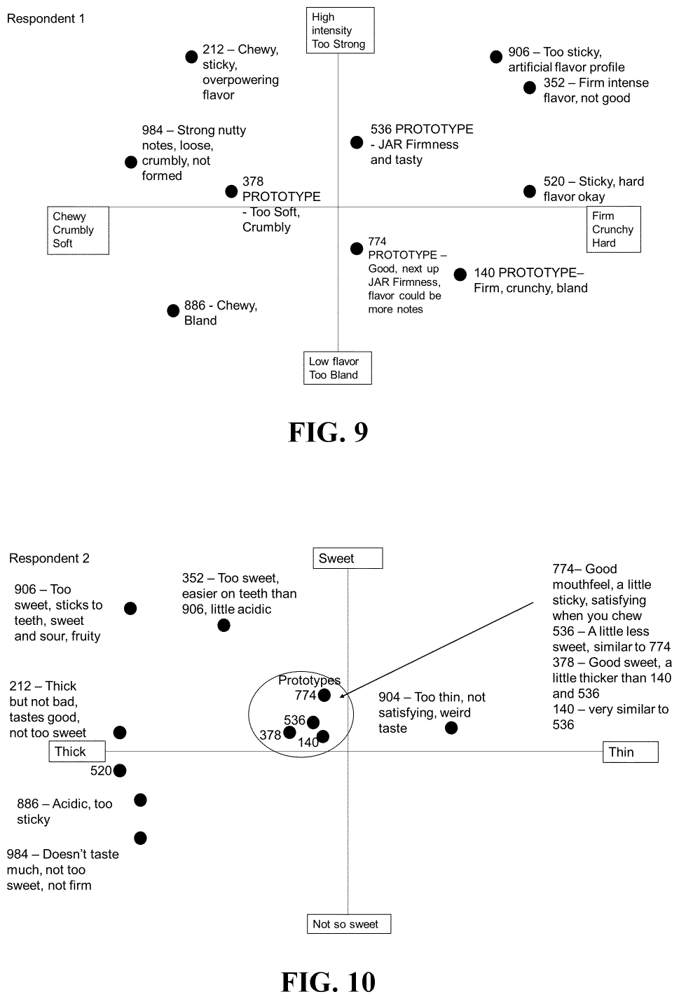

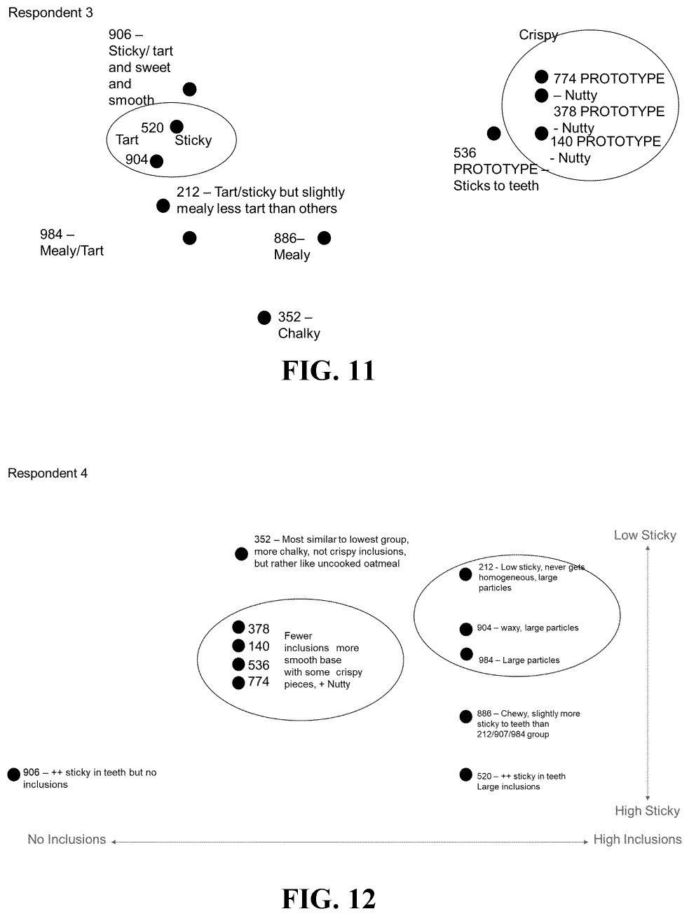

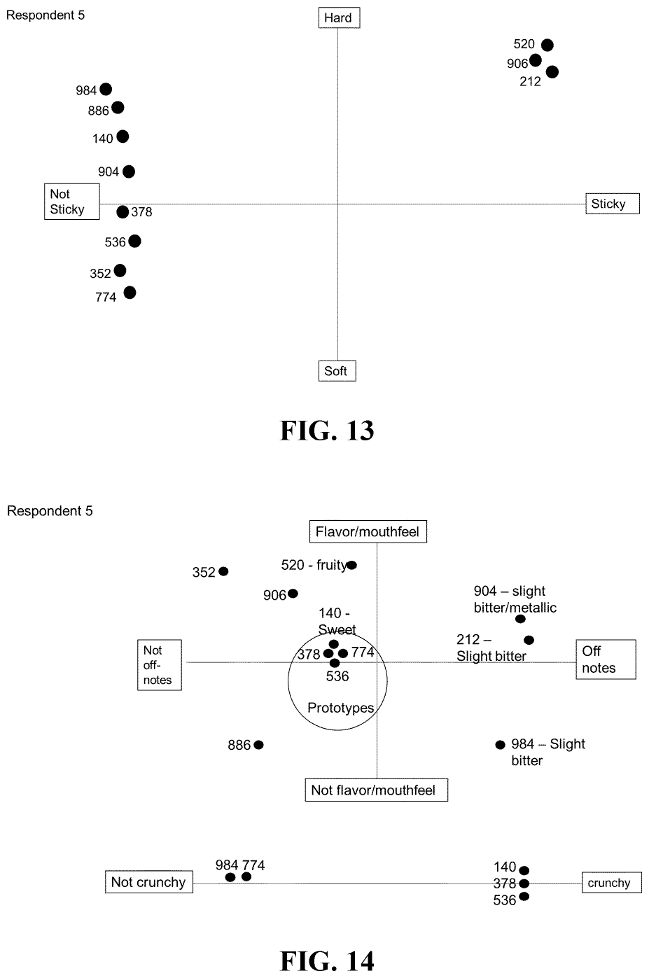

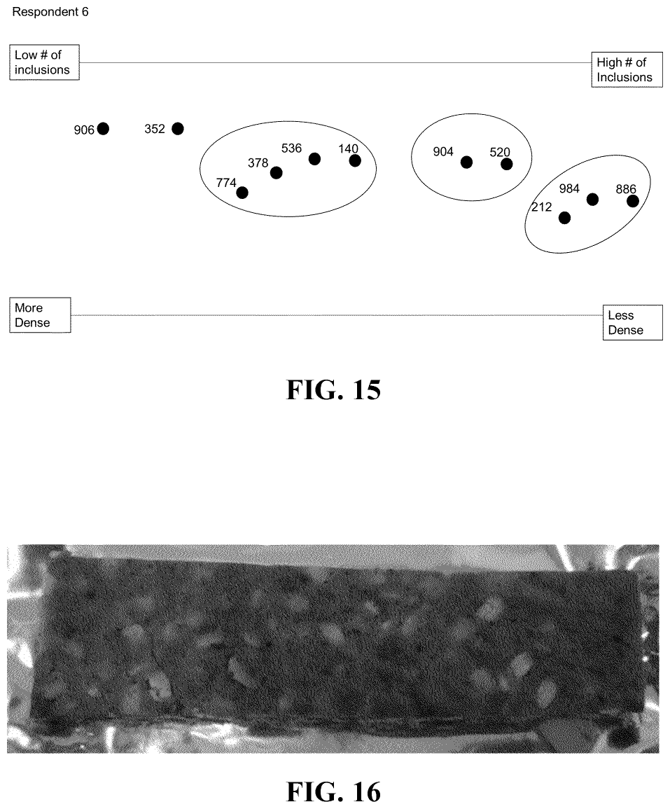

FIGS. 9-15 show the sensory maps of the above products. Table 9 below summarizes the mapping results of the tested prototypes and commercial products.

| Product | Appearance | Texture | Flavor | Basic Taste |
|---|---|---|---|---|
| 774 | Large white | Slightly more | Moderate protein | Low |
| Prototype 1 | inclusions than | cake like | flavor | sweetness |
| (sv-1-12-26) | 378, | Crunchy | Nutty (2) | |
| | | Slightly | Flavor could be | |
| | | cohesive | more intense | |
| | | Sticky to teeth | | |
| | | (2) | | |
| | | Just about right | | |
| | | firmness | | |
| | | Crispy | | |
| 140 | More base | Crispy/Crunchy | Low flavor | Less sweet |
| Prototype 2 | pieces | (3) | impact | |
| (sv-3-12-26) | Low | Low sticky to | Low fruity flavor | |
| | inclusions | teeth (2) | Bland | |
| | | Low chalky, | Nutty | |
| | | Chewy | | |
| | | Firm | | |
| 378 | Tan in color | Softer | Lower protein | Salty |
| Prototype 3 | with white, | Crunchy/Crispy | note | More savory |
| (sv-1-01-07) | small | (2) | Nutty/peanutty | |
| | particulates | Too soft | (2) | |
| | More cake | Crumbly | | |
| | like in | | | |
| | appearance | | | |
| | A little thicker | | | |
| 536 | Light tan with | Crunchy | Nutty | Savory |
| Prototype 4 | white | inclusions | | A little less |
| (sv-2-01-07) | | Just-about-right | | sweet |
| | | firmness | | |
| | | Sticks more to | | |
| | | teeth | | |
| 352 | Dark | Sticky to teeth | Cocoa | Low to moderate |
| BSC Clean | brown/chocolate | (2) | Dried fruit/ | sweetness |
| bar - choc | appearance with | Chalky (2) | prune/date flavor | Too sweet |
| lamington | small speckles | Low chewy (2) | Nutty notes | Little acidic |
| | with inclusions | Small particles | Intense flavor | |
| | Dark brown, | (2) | (not good) | |
| | high visual | Cake/fudge like | | |
| | compaction, | texture | | |
| | small | Dense oatmeal | | |
| | homogeneous | texture | | |
| | inclusion | | | |
| | (oatmeal?, | | | |
| | singular, not | | | |
| | recognizable), | | | |
| | shorter and | | | |
| | fatter | | | |
| 904 | Moderate | Waxy texture | Dark chocolate | ++bitter |
| Planet food | amount of | Large particles | Dried fruit flavor | Tart |
| fruit and | inclusions, | Low chewy | High Brown fruit | |
| nut bar with | Too thin | Low chalky | (dates) note | |
| maple syrup | Chocolate | Sticky | Weird taste | |
| with a dark | covered, matte | | | |
| chocolate | in appearance, | | | |
| coating | rectangular, thin | | | |
| | and flat | | | |
| 984 | Looks more | Gritty | Chocolate | Savory |
| Flexi by | aerated | Never gets | Strong nutty | Sweet |
| impromy | Large | homogenous in | notes | Not sweet |
| meal bar - | inclusions (lots | mouth | Bland | Tart |
| whole grain | of different | Low | | |
| with | kinds, | compaction/dense | | |
| protein, | recognizable), | (3) | | |
| cranberries, | chocolate | Low chewy | | |
| chia, and | drizzle, matte in | Firm | | |
| chocolate | appearance, low | Hard | | |
| | visual | particulates | | |
| | compaction | Chewy, stuck to | | |
| | | mouth to teeth | | |
| | | Loose/crumbly, | | |
| | | Not formed | | |
| | | Not firm | | |
| | | Mealy | | |
| 520 | Shiny | Sticky (4) | High flavor | Tart |
| Isowhey - | Moderately | Chewy (2) | intensity | |
| berry meal | large inclusions | Hard | Very strong off | |
| replacement | Large | Dense | note/medicinal (2) | |
| bar | inclusions (lots | Firm | | |
| | of different | Large particles | | |
| | kinds, | | | |
| | recognizable), | | | |
| | shiny | | | |
| | appearance, | | | |
| | appears sticky, | | | |
| | moderate to | | | |
| | high visual | | | |
| | compaction | | | |
| 906 | Light | Very sticky to | ++flavor | Sweet |
| Keto | tan/brown with | teeth (5) | intensity Coconut, | Sour |
| brownie bite - | no inclusions | No particles/smooth | fruity top note | Low |
| berry | but with | (2) | Fruity | sweetness, |
| | particles on top | Dense, | Fruity | Too sweet |
| | Cocoa like/ | Very firm | Intense artificial | Tart |
| | fudge like | texture | flavor profile | |
| | appearance | Very | | |
| | Light reddish | chewy/cohesive | | |
| | brown, pink | | | |
| | flakes on top, | | | |
| | strong berry | | | |
| | aroma, square, | | | |
| | no visible | | | |
| | inclusions | | | |
| 212 | Flaky | Never gets | Overpowering | Tart (less |
| Carman's | appearance, | homogenous in | flavor | than others) |
| Super Berry | looks dense but | mouth (2) | | Not too sweet |
| Muesli Bar | with plenty of | Sticky (4) | | |
| Cranberry, | air pockets, | Slight firm bite | | |
| blueberry | large dried fruit | Chewy | | |
| and goji | chunks, | Mealy | | |
| | oatmeal, | Large particles | | |
| | Thick | | | |
| | Mostly | | | |
| | oatmeal, lots of | | | |
| | large inclusions | | | |
| | that are not | | | |
| | homogenously | | | |
| | dispersed but | | | |
| | mostly | | | |
| | recognizable, | | | |
| | moderate visual | | | |
| | compaction, | | | |
| | moderate shiny | | | |
| | appearance | | | |
| 886 | Inclusions | Large particles | Moderate flavor | Sour/acidic |
| Barley + | included oat, nut | Very firm | intensity | (2), |
| Wild Berry | particulates, | Not dense, | Fruity | Low to |
| and yoghurt | dried fruit | Chewy (3) | Bland | moderate |
| bar with | pieces | Sticky (2) | | sweetness |
| whole grain | Very shiny | Mealy | | |
| barley | appearance, | | | |
| flakes, oats, | mostly oatmeal | | | |
| cranberries, | and protein | | | |
| blueberries | crisps, lots of | | | |
| and yogurt | large | | | |
| | recognizable | | | |
| | inclusions that | | | |
| | are | | | |
| | homogeneously | | | |
| | dispersed. | | | |

Tables 10-12 below list all the products tested.

TABLE 10

| Blind | | |
|---|---|---|
| Code | Product Name | Full bar notes |
| 906 | Keto brownie bite - berry | Light reddish brown, |
| | | pink flakes on top, strong |
| | | berry aroma, square, no |
| | | visible inclusions |
| 904 | Planet food fruit and nut bar with | Chocolate covered, matte |
| | maple syrup with a dark | in appearance, |
| | chocolate coating | rectangular, thin and flat |
| 520 | Isowhey - berry meal | Large inclusions (lots of |
| | replacement bar | different kinds, |
| | | recognizable), shiny |
| | | appearance, appears |
| | | sticky, moderate to high |
| | | visual compaction |
| 984 | Flexi by impromy meal bar - | Large inclusions (lots of |
| | whole grain with protein, | different kinds, |
| | cranberries, chia, and chocolate | recognizable), chocolate |
| | | drizzle, matte in |
| | | appearance, low visual |
| | | compaction |

TABLE 11

| Blind | | |
|---|---|---|
| Code | Product Name | Full bar notes |
| 352 | BSC Clean bar - choc | Dark brown, high visual |
| | lamington | compaction, small |
| | | homogeneous inclusion |
| | | (oatmeal?, singular, not |
| | | recognizable), shorter and |
| | | fatter |
| 212 | Carman's Super Berry Muesli | Mostly oatmeal, lots of |
| | Bar Cranberry, blueberry and | large inclusions that are |
| | goji | not homogenously |
| | | dispersed but mostly |
| | | recognizable, moderate |
| | | visual compaction, |
| | | moderate shiny |
| | | appearance |
| 886 | Barley + Wild Berry and yoghurt | Very shiny appearance, |
| | bar with whole grain barley | mostly oatmeal and |
| | flakes, oats, cranberries, | protein crisps, lots of |
| | blueberries and yogurt | large recognizable |
| | | inclusions that are |
| | | homogeneously |
| | | dispersed. |

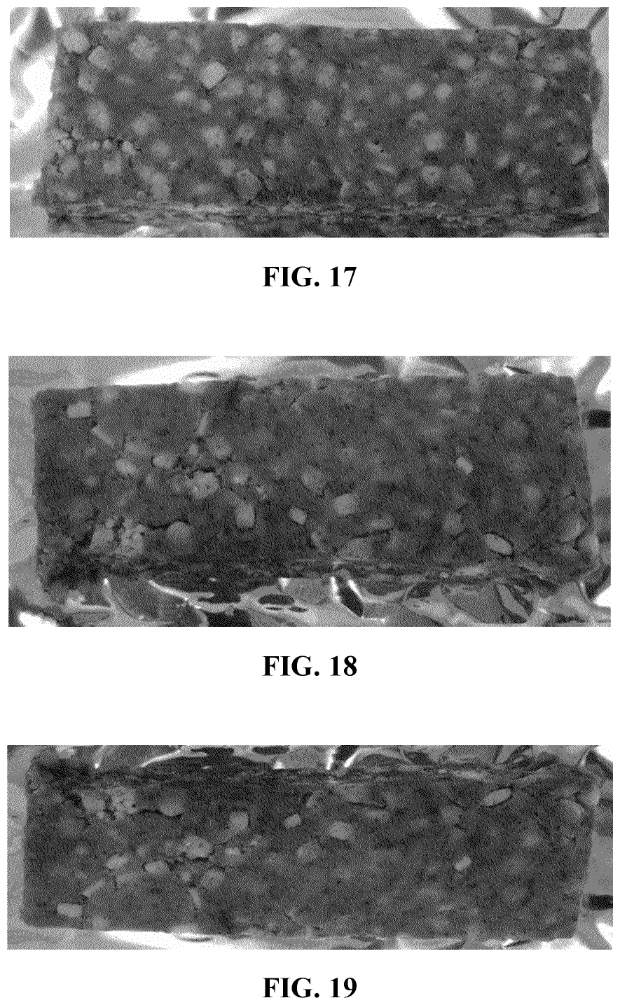

TABLE 12

| Blind | Product | Full bar | |
|---|---|---|---|
| Code | Name | notes | Picture |
| 774 | Prototype 1 | Light to | FIG. 16 |
| | (sv-1-12-26) | moderate | |
| | | brown color | |
| 140 | Prototype 2 | with darker | FIG. 17 |
| | (sv-3-12-26) | brown specks, | |
| | | moderate | |
| 378 | Prototype 3 | number of | FIG. 18 |
| | (sv-1-01-07) | puffed inclusions, | |
| | | primary | |
| 536 | Prototype 4 | base looks | FIG. 19 |
| | (sv-2-01-07) | doughy | |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of making a meal replacement bar, the method comprising:
providing a base material comprising at least one real food and natural ingredient comprising proteins, carbohydrates, fats, and/or fiber;
providing at least one natural binding agent to bind together the base material, wherein the at least one natural binding agent is selected from the group consisting of honey, chicory root syrup, dates paste, and mixtures thereof and is in an amount effective for the meal replacement bar to maintain a shape; and
providing additional ingredients comprising vitamins and minerals to form a final mixture.

2. The method of claim 1 further comprising:
shaping the final mixture in a mold; and
cutting the molded final mixture into the meal replacement bar.

3. The method of claim 1, wherein the at least one real food and natural ingredient comprises a natural protein source selected from the group consisting of a milk protein concentrate, a milk protein isolate, a whey protein concentrate, a whey protein isolate, a whey protein hydrolysate, a casein, a plant protein, and mixtures thereof.

4. The method of claim 1, wherein the at least one real food and natural ingredient comprises at least one grain or seed.

5. The method of any of claim 1, wherein the meal replacement bar provides about 100-300 kcal energy and about 8-30 g of protein per 44 g or 55 g of the meal replacement bar.

6. A method of making a meal replacement bar, the method comprising:
mixing at least one natural binding agent with vitamins, minerals and/or a flavoring ingredient to form a mixture, wherein the at least one natural binding agent is selected from the group consisting of honey, chicory root syrup, dates paste, and mixtures thereof and is in an amount effective for the meal replacement bar to maintain a shape;
mixing at least one real food and natural ingredient with the mixture to form a homogenous mixture; and
mixing a natural protein crisp with the homogenous mixture to form a final mixture, wherein the natural protein crisp stays intact during and after the mixing.

7. The method of claim 6 further comprising:
shaping the final mixture in a mold; and
cutting the molded final mixture into the meal replacement bar.

8. The method of claim 6, wherein the at least one real food and natural ingredient comprises a natural protein source selected from the group consisting of a milk protein concentrate, a milk protein isolate, a whey protein concentrate, a whey protein isolate, a whey protein hydrolysate, a casein, a plant protein, and mixtures thereof.

9. The method of claim 6, wherein the at least one real food and natural ingredient comprises at least one grain or seed.

10. A meal replacement bar comprising:
a base material comprising at least one real food and/or natural ingredient comprising proteins, carbohydrates, fats, and/or fiber
at least one natural binding agent to bind together the base material, wherein the at least one natural binding agent is selected from the group consisting of honey, chicory root syrup, dates, dates paste, and mixtures thereof and is in an amount effective for the meal replacement bar to maintain a shape; and
vitamins and minerals.

11. The meal replacement bar of claim 10, wherein the at least one natural binding agent is dispersed substantially homogeneously in the meal replacement bar.

12. The meal replacement bar of claim 10, wherein each of ingredients of the meal replacement bar is dispersed substantially homogeneously throughout the meal replacement bar.

13. The meal replacement bar of claim 10, wherein the meal replacement bar comprises about 9.0 wt. % to about 12.0 wt. % of chicory root syrup.

14. The meal replacement bar of claim 10, wherein the meal replacement bar comprises about 8.0 wt. % to about 13.0 wt. % honey.

15. The meal replacement bar of claim 10, wherein the meal replacement bar comprises about 12.0 to about 18.0 wt. % of dates paste.

16. The meal replacement bar of claim 10, wherein the at least one real food and/or natural ingredient comprises a natural protein source selected from the group consisting of a milk protein concentrate, a milk protein isolate, a whey protein concentrate, a whey protein isolate, a whey protein hydrolysate, a casein, a plant protein, and mixtures thereof.

17. The meal replacement bar of claim 10, wherein the natural protein source comprises a butter from one or more nuts or seeds.

18. The meal replacement bar of claim 10, wherein the meal replacement bar comprises about 100-300 kcal energy and/or about 8-30 g of protein per 44 g or 55 g of the meal replacement bar.

19. The meal replacement bar of claim 10, wherein the meal replacement bar does not contain polyols, guar gum, maltodextrin, monosodium glutamate (MSG), xanthan gum, hydrogenated fat, carrageenan, monoglyceride, diglyceride, caseinate, microcrystalline cellulose (MCC), carboxymethylcellulose (CMC), or hydroxypropyl methylcellulose (HPMC).

20. The meal replacement bar of claim 10, wherein the meal replacement bar comprises less than 15 ingredients in total.
